(19) United States
(12) Patent Application Publication
(10) Pub. No.: US 2015/0142627 A1
(43) Pub. Date: May 21, 2015

(54) GRAPHICAL USER INTERFACE FOR INVESTIGATION OF SUSPICIOUS ACTIVITY WITHIN A FINANCIAL INSTITUTION

(71) Applicant: BANK OF AMERICA CORPORATION, Charlotte, NC (US)

(72) Inventor: Alvin Lee, Charlotte, NC (US)

(73) Assignee: BANK OF AMERICA CORPORATION, Charlotte, NC (US)

(21) Appl. No.: 14/085,197

(22) Filed: Nov. 20, 2013

(51) Int. Cl. G06Q 30/00; G06Q 40/00

(52) U.S. Cl. CPC G06Q 30/0185; G06Q 40/00
USPC 705/35

(57) ABSTRACT

Embodiments of the invention are directed to apparatus, methods, and computer program products for generating a Graphical User Interface (GUI) that provides an individual or entity tasked with investigating suspicious financial institution activity immediate insight into the relationship between the parties involved and the numerous suspicious activity events, the relationships between the parties, and the relationship between suspicious activity events as it pertains to time of occurrence and types of events. Moreover, the dynamic nature of the elements illustrated in the GUI provides the investigator visual flexibility that aids in verifying the suspicious aspect of an event, identifying events that are normal business activity, and identifying potential illegal activity suspects.

### FIELD

In general, embodiments of the invention relate to methods, systems, apparatus and computer program products for investigating suspicious activity within a financial institution and, more specifically, generating a graphical user interface (GUI) that illustrates in a unified display the correlation between (1) suspicious activity events, (2) parties associated with suspicious activity and (3) the suspicious activity events and the parties.

### BACKGROUND

Financial institutions are often tasked with investigating whether certain suspicious financial activities conducted by customers and/or internal parties are related to Anti-Money Laundering (AML) or other forms of illegal activity. Such investigation may typically entail analyzing various suspicious activity events (i.e., financial transactions and the like) conducted by multiple parties (e.g., an individual or a group of individuals, such as a business or the like) that may related by a common attribute (e.g., holders of a joint account, members of a same household or family, same employer/business associates, parties to a transaction or the like). Investigations that involve multiple related parties, commonly referred to as a network or “ring” of suspects, may be complex in nature and involve hundreds, if not thousands, of suspicious activity events and the various different related common attributes.

In current investigatory processing, information is presented to the investigator in a table or chart format, which typically lists, in line and row format, the suspicious activity event, denotes the type of suspicious activity event, the date of occurrence of the suspicious activity event, the parties involved in the suspicious activity and the like. However, providing such information in this linear format does not allow the investigator immediate insight into how suspicious activity events are related, in terms of time of occurrence and event type. Moreover, such linear presentation of data does not provide the investigator with knowledge of the totality of the relationships between the numerous suspicious activity events and the multiple parties involved and the relationships amongst the multiple parties involved.

Therefore, a need exists for generating a visual presentation that provides an investigator with immediate insight into the relationship between the parties involved and the numerous suspicious activity events (i.e., which parties are associated with which events) and the relationships between the parties (i.e., the common attribute that connects one party to one or more other parties). In addition, the desired visual presentation should the relationship between suspicious activity events as it pertains to time of occurrence and types of events. As such, the desired systems, methods and computer program products should assist the investigator in performing a more efficient and effective investigation by aiding in verifying suspicious events, identifying events that are normal business activity and identifying potential suspects.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for generating a Graphical User Interface (GUI) that provides an individual or entity tasked with investigating suspicious financial institution activity immediate insight into (1) the relationship between the parties involved and the numerous suspicious activity events (i.e., which parties are associated with which events) and (2) the relationships between the parties (i.e., the common attribute that connects one party to one or more other parties). In addition, the GUI of the present provides immediate insight into (3) the relationship between suspicious activity events as it pertains to time of occurrence and types of events. Moreover, the dynamic nature of the elements illustrated in the GUI provides the investigator visual flexibility that aids in (a) verifying that a suspicious event is, in fact, suspicious; (b) identifying events that are normal business activity (i.e., isolating events that are “noise”); and (c) identifying potential suspects.

An apparatus for generating a graphical user interface (GUI) configured for investigating suspicious activity in a financial institution defines first embodiments of the invention. The apparatus includes a computing platform having a memory and at least one processor in communication with the memory. The apparatus further includes a GUI-generating module that is stored in the memory and executable by the processor. The module is configured and configured to receive data associated with suspicious financial institution activity, the data includes (1) a plurality of suspicious activity events having an associated date, (2) a plurality of parties associated with the suspicious events and (1) one or more relationships that associate two or more of the parties. The module is further configured to generate a graphical user interface (GUI) that displays (a) a plurality of event icons, each event icon associated with one of the plurality of suspicious activity events, wherein each event icon is displayed in relation to a timeline based on the associated date corresponding to the suspicious activity event, (b) a plurality of party icons, each party icon associated with one of the plurality of parties, (c) one or more relationship icons, each relationship icon associated with one of the one or more relationships, (d) first links between each of the event icons and one or more party icons, wherein the first links are configured to provide a correlation between a suspicious activity event and the one or more parties associated with the suspicious activity event, and (e) second links between each of the one or more relationship icons and one or more of the party icons, wherein the second links are configured to provide a correlation between two or more parties and a relationship that associates the two or more parties.

In accordance with specific embodiments of the apparatus, the GUI-generating module is further configured to generate the GUI that displays the plurality of party icons, wherein the party icons are moveable icons within the display, wherein movement of a party icon serves to (1) verify suspicious nature of correlated suspicious activity events or (2) identify correlated suspicious activity events as normal business behavior. In related embodiments of the apparatus, movement of a party icon provides for movement of the first and second links associated with the party icon. In other embodiments of the apparatus, the GUI-generating module is further configured to generate the GUI that displays the plurality of relationship icons, wherein the relationship icons are moveable icons within the display, wherein movement of a relationship icon provides for movement of the second links associated with the relationship icon.

In further embodiments of the apparatus, the GUI-generating module is configured to receive the data associated with the suspicious financial institution activity and generate the GUI in automatic response to the suspicious financial institution activity being associated with a risk score that exceeds a threshold for designating the suspicious financial institution activity as a case for investigation. For further related discussion, see, U.S. patent application Ser. No. 12/887,202, entitled “Event Processing for Detection of Suspicious Financial Activity,” filed on Sep. 21, 2010, assigned to the same assignee as the present invention and is herein incorporated by reference as if setforth fully herein. In such embodiments of the apparatus, the GUI-generating module is further configured to generate the GUI that displays a case indicator in relation to the timeline, wherein the case indicator provides an indication of when the suspicious financial institution activity was designated as the case.

In still further embodiments of the apparatus, the GUI-generating module is configured to generate the GUI that displays the timeline that is scaled relative to (1) a first date corresponding to an occurrence of a first-in-time suspicious activity event and (2) a second date corresponding to an occurrence of a case being established.

Moreover, in other embodiments of the apparatus, the GUI-generating module is further configured to generate the GUI that displays the plurality of event icons, wherein the event icons are grouped in the display according to suspicious activity event type. In still further embodiments of the apparatus, the GUI-generating module is further configured to generate the GUI that displays the one or more relationship icons, wherein the relationship icons visually indicate a type of relationship associated with the relationship icon.

A method for generating a graphical user interface (GUI) and implementing the GUI for investigating suspicious activity in a financial institution, defines second embodiments of the invention. The method includes receiving data associated with suspicious financial institution activity, including (1) a plurality of suspicious activity events having an associated date, (2) a plurality of parties associated with the suspicious events and (1) one or more relationships that associate two or more of the parties. The method further includes generating a graphical user interface (GUI) that displays (a) a plurality of event icons, each event icon associated with one of the plurality of suspicious activity events, wherein each event icon is displayed in relation to a timeline based on the associated date corresponding to the suspicious activity event, (b) a plurality of party icons, each party icon associated with one of the plurality of parties, (c) one or more relationship icons, each relationship icon associated with one of the one or more relationships, (d) first links between each of the event icons and one or more party icons, wherein the first links are configured to provide a correlation between a suspicious activity event and the one or more parties associated with the suspicious activity event, and (e) second links between each of the one or more relationship icons and one or more of the party icons, wherein the second links are configured to provide a correlation between two or more parties and a relationship that associates the two or more parties. In addition, the method includes implementing the GUI to investigate the suspicious financial institution activity.

In further embodiments of the method, generating the GUI further includes generating the GUI that displays the plurality of party icons, wherein the party icons are moveable icons within the display. In such embodiments the method may further include receiving a user input that is configured to move a party icon within the display to perform one of (1) verify suspicious nature of correlated suspicious activity events or (2) identify correlated suspicious activity events as normal business behavior.

In other embodiments of the method, generating the GUI further includes generating the GUI that displays the plurality of relationship icons, wherein the relationship icons are moveable icons within the display. In such embodiments the method may further include receiving a user input that is configured to move a relationship icon to add clarity to the GUI.

In still further embodiments the method includes determining a risk score associated with the suspicious financial institution activity, and identifying the suspicious financial institution activity as a case for investigation based on the risk score exceeding a threshold for designating the suspicious financial institution activity for case investigation. In such embodiments receiving the data further includes receiving the data associated with the suspicious financial institution activity in automatic response to identifying the suspicious financial institution activity as the case for investigation.

In additional specific embodiments of the method generating the GUI further includes generating the GUI that displays a case indicator in relation to the timeline. The case indicator provides an indication of when the suspicious financial institution activity was designated as the case. In other additional embodiments of the method generating the GUI further includes generating the GUI that displays the timeline, wherein the timeline is scaled relative to (1) a first date corresponding to an occurrence of a first-in-time suspicious activity event and (2) a second date corresponding to an occurrence of a case being established. In still further embodiments of the method, generating the GUI further comprises generating the GUI that displays the plurality of event icons, wherein the event icons are grouped in the display according to suspicious activity event type. Moreover, in additional embodiments of the method generating the GUI further includes generating the GUI that displays the one or more relationship icons, wherein the relationship icons visually indicate a type of relationship associated with the relationship icon.

A computer program product including a non-transitory computer-readable medium defines third embodiments of the invention. The computer-readable medium includes a first set of codes for causing a computer to receive data associated with suspicious financial institution activity, including (1) a plurality of suspicious activity events having an associated date, (2) a plurality of parties associated with the suspicious events and (1) one or more relationships that associate two or more of the parties. The computer-readable medium also includes a second set of codes for generating a graphical user interface (GUI) that displays (a) a plurality of event icons, each event icon associated with one of the plurality of suspicious activity events, wherein each event icon is displayed in relation to a timeline based on the associated date corresponding to the suspicious activity event, (b) a plurality of party icons, each party icon associated with one of the plurality of parties, (c) one or more relationship icons, each relationship icon associated with one of the one or more relationships, (d) first links between each of the event icons and one or more party icons, wherein the first links are configured to provide a correlation between a suspicious activity event and the one or more parties associated with the suspicious activity event, and (e) second links between each of the one or more relationship icons and one or more of the party icons, wherein the second links are configured to provide a correlation between two or more parties and a relationship that associates the two or more parties.

Thus, embodiments of the present invention, which are described in more detail below, provide for generating a Graphical User Interface (GUI) that provides an individual or entity tasked with investigating suspicious financial institution activity immediate insight into (1) the relationship between the parties involved and the numerous suspicious activity events, and (2) the relationships between the parties. In addition, the GUI of the present provides immediate insight into (3) the relationship between suspicious activity events as it pertains to time of occurrence and types of events. Moreover, the dynamic nature of the elements illustrated in the GUI provides the investigator visual flexibility that aids in (a) verifying that a suspicious event is, in fact, suspicious; (b) identifying events that are normal business activity; and (c) identifying potential suspects.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram representation of an apparatus for generating a Graphical User Interface (GUI) for investigation of suspicious activity within a financial institution, in accordance with embodiments of the present invention;

FIG. 2 is an exemplary Graphical User Interface (GUI) for investigation of suspicious activity within a financial institution, in accordance with embodiments of the present invention;

FIG. 3 is a more detailed diagram of an apparatus for generating a GUI for investigation of suspicious activity within a financial institution, in accordance with embodiments of the present invention;

FIGS. 4A and 4B are examples of a GUI for investigation of suspicious activity highlighting the moveable icon feature, in accordance with embodiments of the present invention; and

FIG. 5 is a flow diagram of a method for generating a Graphical User Interface (GUI) for investigation of suspicious activity within a financial institution, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that investigate suspicious activity.

Thus, systems, apparatus, methods and computer program programs are herein described which generate a Graphical User Interface (GUI) that aids in the investigation of suspicious financial institution activity. Specifically, the GUI of the present invention, through the implementation of visual links, provides an individual or entity tasked with investigating suspicious financial institution activity immediate insight into (1) the relationship between the parties involved and the numerous suspicious activity events (i.e., which parties are associated with which events) and (2) the relationships between the parties (i.e., the common attribute that connects one party to one or more other parties). In addition, the GUI of the present provides immediate insight into (3) the relationship between suspicious activity events as it pertains to time of occurrence and types of events. Moreover, the fluid “moveable” nature of the elements illustrated in the GUI provides the investigator visual flexibility that aids in (a) verifying that a suspicious event is, in fact, suspicious; (b) identifying events that are normal business activity (i.e., isolating events that are “noise”); and (c) identifying potential suspects.

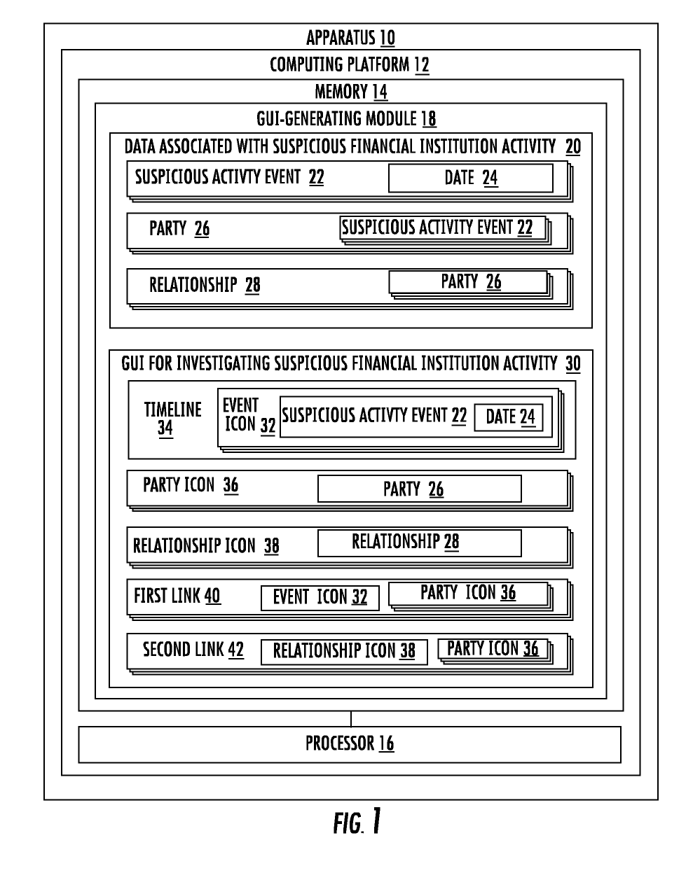

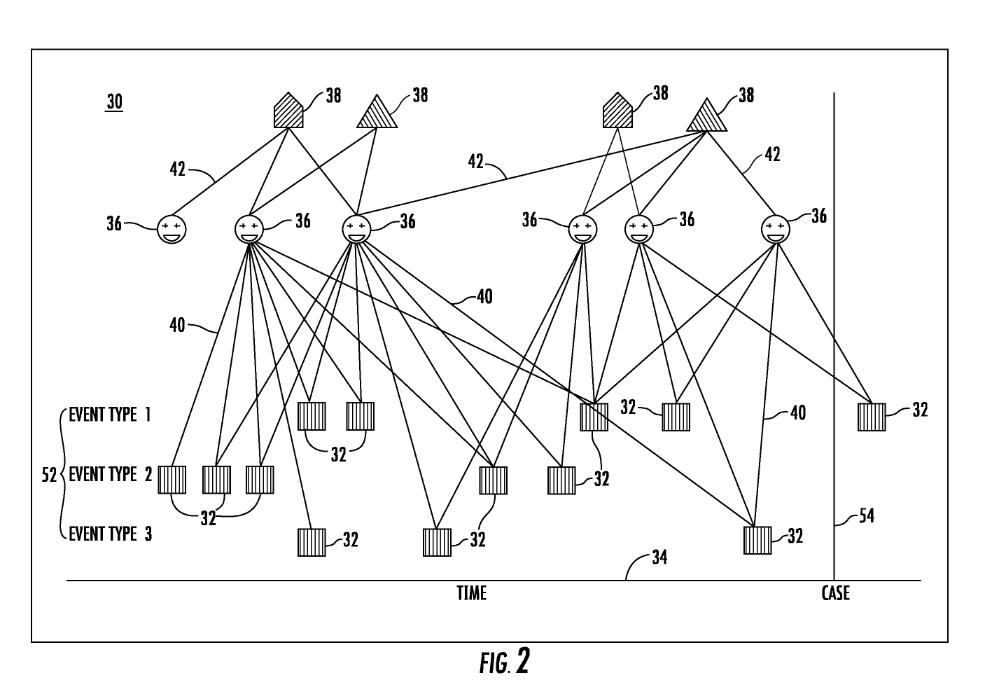

Referring to FIGS. 1 and 2, FIG. 1 presents a block diagram of an apparatus 10 for generating a GUI for investigating suspicious financial institution activity and FIG. 2 provides an example of such a GUI, in accordance with embodiments of the present invention. The apparatus 10, which may include more than device, includes a computing platform 12 having a memory 14 which is in communication with processor 16.

Memory 14 stores GUI-generating module 18 that is configured to receive data 20 associated with suspicious financial institution activity. In specific embodiments the data will be received by the GUI-generating module in response to the financial institution determining that the suspicious financial institution activity warrants further investigation (i.e., has been elevated to the “case-level”, which requires investigation) to determine if the suspicious activity requires government notification, in the form of a Suspicious Activity Report (SAR) or the like. It should be noted that if an investigation leads to regulatory reporting (i.e., generation and communication of a SAR), the GUI herein generated may be sent to the regulatory agency, as well.

The data associated with suspicious activity includes a plurality of related suspicious activity events 22, including a date of occurrence 24. The suspicious activity event 22 is any transaction or other financial institution encounter or event that may be associated with money laundering or illegal activity. For examples, suspicious activity events 22 may include, but are not limited to, wire transfer transactions above a specified amount, above a specified frequency or originating from or being destined for certain countries. Various systems within a financial institution are configured to continuously monitor and track the occurrence of such suspicious activity events 22.

In addition, systems within a financial institution are configured to determine that a group of suspicious activities are “related” based on a connection or relationship between the parties involved in the suspicious financial institution events 22. Therefore, the data 20 associated with the suspicious financial institution activity includes a plurality of parties 26 associated with the suspicious activity events 22 and the one or more relationships 28 that associate or connect two or more parties 26.

A “party” 26, as used herein, may be an individual or a group of individuals (e.g., a business, an association or the like) and may be external to the financial institution (e.g., customers) or internal (e.g., employees/associates). Additionally, an identified party 26 may be associated with a single suspicious activity event 22 or a plurality of the related suspicious activity events 22. The “association” between the party 26 and the suspicious activity event 22 means that the party 26 conducted or otherwise participated in the suspicious activity event 22.

A “relationship” 28, as used herein, may be any connection that a financial institution can determine which links one party to another party. Examples of relationships include, but are not limited to, common household/same address, holders of joint accounts, parties to one or more transactions (e.g., buyer and seller), common employer, parties employed by affiliated companies, common owner of businesses associated with parties, common business location/address and the like.

In response to receiving the data 20, the GUI-generating module 18 is configured to generate the GUI 30, which is configured to aid an investigator in performing the investigation of the suspicious activity. The GUI 30, an example of which is shown in FIG. 2 includes a plurality of event icons 32, each event icon 32 corresponding to one of the plurality of suspicious activity events 22. Each event icon 32 is displayed in the GUI in relation to a timeline 34 based on the date of occurrence 24 associated with the corresponding suspicious activity event 22. In specific embodiments, the timeline may be scaled based on the date of occurrence 24 of the first-in-time suspicious activity event and the date of occurrence 56 of a case being established. As depicted, the timeline 34 may be configured to not indicate specific dates along the timeline 34, while in other embodiments the timeline 34 may be configured to indicate the date of the first-in-time and last-in-time suspicious activity and/or interval dates along the timeline.

The GUI 30 additionally includes a plurality of party icons 36, each party icon 36 corresponding to one of the plurality of parties 26 related to the suspicious activity events 22. Additionally, the GUI includes one or more relationship icons 38, each relationship icon corresponding to one of the relationships 28 that connect two or more parties 26.

Moreover, GUI 30 additionally includes a plurality of first links 40 and second links 42. The first links 40, which in the example of FIG. 2 are configured as lines, associate the event icons 32 with one or more party icons 36. As such the first links 40 are configured to indicate which parties 26 are associated with which suspicious activity events 22. From an investigation perspective the first links allow the investigator to visualize the association between suspicious activity events 22 and the parties 26 involved in those events 22. The second links 42, which in the example of FIG. 2 are also configured as lines, associate the relationship icons 38 with two or more party icons 36. As such, the second links 42 are configured to indicate relationships 28 between two or more parties 26 that are related to the suspicious activity events 22. From an investigation perspective the second links allow the investigator to visualize the relationships 28 that exist between parties 26.

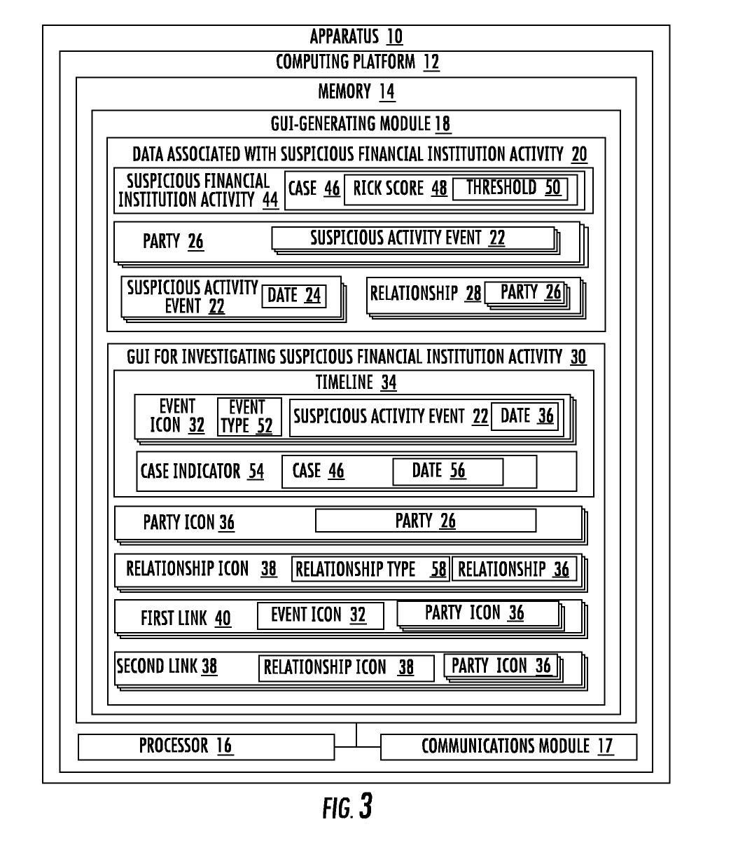

Referring to FIG. 3 shown is a more detailed block diagram of apparatus 10, according to embodiments of the present invention. As previously described, the apparatus 10 is configured to generate a Graphical User Interface (GUI) for investigating suspicious activity within a financial institution. In addition to providing greater detail, FIG. 3 highlights various alternate embodiments of the invention. The apparatus 10 may include one or more of any type of computerized device. The present apparatus and methods can accordingly be performed on any form or combination of computing devices, including servers, personal computing devices, laptop/portable computing devices, mobile computing devices or the like.

The apparatus 10 includes computing platform 12 that can receive and execute routines and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 3) that interfaces with any resident programs, such as GUI-generating module 18 or the like stored in the memory 14 of the apparatus 10.

Processor 14 may include various processing subsystems (not shown in FIG. 3) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 16 may include any subsystem used in conjunction with GUI-generating module 18 or subcomponents or sub-modules thereof.

Computer platform 12 additionally includes communications module 17 embodied in hardware, firmware, software, and combinations thereof, that enables communications among the various components of the apparatus 10, as well as between the other devices in the unified account payment recovery system. Thus, communication module 17 may include the requisite hardware, firmware, software and/or combinations thereof for establishing a network communication connection and initiating communication amongst networked devices for the purpose of disseminating the generated GUI to investigators or the like.

As previously noted, the memory 16 of computing platform 12 stores GUI-generating module 18 that is configured to receive data 20 associated with suspicious financial institution activity. In specific embodiments the data 20 will be received by the GUI-generating module and the GUI generated in response to the financial institution determining that the suspicious financial institution activity 44 has been elevated to a case 46. As previously noted, case-level investigation is warranted to determine if the suspicious financial institution activity requires third party and/or government notification, in the form of a Suspicious Activity Report (SAR) or the like. In specific embodiments of the invention, the data 20 will be received by the GUI-generating module and the GUI generated in automatic response to the financial institution determining that the suspicious financial institution activity 44 has been elevated to a case 46. In such embodiments of the invention, a risk score 48 may be implemented to determine the risk associated with the suspicious financial institution activity 44 and, once the risk score 48 reaches or exceeds a predetermined risk score threshold 50, the suspicious activity 44 may be automatically designated as a case 46 and the GUI-generating module 18 may, in response to designating the activity 44 as a case 48, automatically receive the data 20 associated with suspicious financial institution activity 44.

As previously discussed in relation to FIG. 1, the data 20 includes a plurality of related suspicious activity events 22, including a date of occurrence 24. In addition, the data 20 includes a plurality of parties 26 associated with the suspicious activity events 22 and the one or more relationships 28 that associate or connect two or more parties 26.

In response to receiving the data 20, the GUI-generating module 18 is configured to generate the GUI 30, which is configured to aid an investigator in performing the investigation of the suspicious activity. In specific embodiments, the GUI-generating module is configured to automatically generate the GUI 30 in response to receiving the data 20. In this regard a GUI is generated once suspicious activity has been elevated to the level of a case 46. In addition, the GUI may be periodically updated throughout the lifespan of the case to indicate the fact that suspicious activity events 22 may occur after the case 46 has been issued and such events 22 need to be reflected on an updated GUI. The period for updating the GUI may be daily, weekly, monthly or the like depending upon the needs of the financial institution and/or the difficulty in assessing the suspicious activity of the case being investigated.

As previously discussed in reference to FIG. 1 and FIG. 2, the GUI 30 includes a plurality of event icons 32, each event icon 32 corresponding to one of the plurality of suspicious activity events 22. Each event icon 32 is displayed in the GUI in relation to a timeline 34 based on the date of occurrence 24 associated with the corresponding suspicious activity event 22. In specific embodiments, the GUI may include a case indicator 54 that indicates a date 56 on which the case 46 was established. In the illustrated example of FIG. 2 the case indicator 54 is a dotted-line proceeding from the timeline 34. The case indicator 54 provides for indication within the GUI of which suspicious activity events 22 occurred prior to the case being established and which suspicious activity events 22 occurred after the case was established. While in the illustrated example of FIG. 2 the actual date on which the case was established is not shown on the timeline, in other embodiments of the GUI the actual date may be visually shown on the timeline 34.

In addition, event icons may be configured within the GUI 30 to indicate event type 52. The event type 52 is the category or type of event that is deemed to be suspicious. For example, the event type may correspond to the mechanism or system within the financial institution used to monitor and record the event. In the illustrated embodiment of FIG. 2, event type is indicated by grouping the event icons 32 according to event type 52, specifically, grouping the event icons 32 in separate rows, each row indicating a different event type 52. In other embodiments of the invention event type 52 may be indicated based on the shape, size and/or color of the event icon 32 or the like.

As discussed in relation to FIG. 1, the GUI 30 also includes a plurality of party icons 36, each party icon 36 corresponding to one of the plurality of parties 26 related to the suspicious activity events 22 and one or more relationship icons 38, each relationship icon corresponding to one of the relationships 28 that connect two or more parties 26. In specific embodiments of the GUI, the relationship icons 38 may visually indicate the relationship type 58. In the illustrated embodiment of FIG. 2, relationship type 58 is indicated based on the shape of the relationship. For example, a house-shaped relationship icon 38 indicates a same household/address relationship between two or more parties 26 and the triangle-shaped relationship icon 38 may indicate a joint account held by two or more parties 26. While in other embodiments of the GUI, relationship type 58 may be visually indicated by the color of the icon, the size of the icon or the location of the icon in the GUI (e.g., grouping based on relationship type).

Moreover, as previously discussed in relation to FIG. 1, GUI 30 additionally includes a plurality of first links 40 and second links 42. The first links 40 associate the event icons 32 with one or more party icons 36. As such the first links 40 are configured to indicate which parties 26 are associated with which suspicious activity events 22. From an investigation perspective the first links allow the investigator to visualize the association between suspicious activity events 22 and the parties 26 involved in those events 22. The second links 42, which in the example of FIG. 2 are also configured as lines, associate the relationship icons 38 with two or more party icons 36. As such, the second links 42 are configured to indicate relationships 28 between two or more parties 26 that are related to the suspicious activity events 22. From an investigation perspective the second links allow the investigator to visualize the relationships 28 that exist between parties 26.

In the illustrated example of FIG. 2 all of the first links 40 and second links 42 that exist are shown in the GUI. However, in alternate embodiments of the GUI, the GUI may be configured to visually display only the links associated with a user-selected event icon 32, party icon 36 or relationship icon 38. In this regard, a user may select one of the icons (e.g., clicking on the icon, hovering over the icon or the like) and, upon selection, only the links associated with that icon are displayed. For example, if the user selects an event icon 32, only the first links 40 to the party icons 36 associated with the selected event icon 32 are displayed, and all other links in the GUI are temporarily hidden. In another example, if a user selects a party icon 36, only the first links 40 to the event icon(s) 32 associated with the selected party icon 36 and/or the second links 42 to the relationship icon(s) 38 associated with the selected party icon 36 are displayed, and all other links in the GUI are temporarily hidden. In a further example, if a user selects a relationship icon 38, only the second links 42 to the party icons 36 associated with the relationship icon 38 are displayed, and all other links in the GUI are temporarily hidden.

Additionally, in further embodiments of the invention, the icons 32, 36, and 38 may be activatable (e.g., clicking on the icon, hovering over the icon or the like) to display underlying information related to the event, the party and or the relationship. For example, selection of an event icon 32 may display event identification (ID), date/time of occurrence, title of event and the like. Selection of a party icon 36 may display the party identification (ID), name of the party or members of the party and the like. Selection of the relationship icon 38 may display the relationship type and, based on the type of relationship, the household address, the account name and number or account identification (ID), and the like.

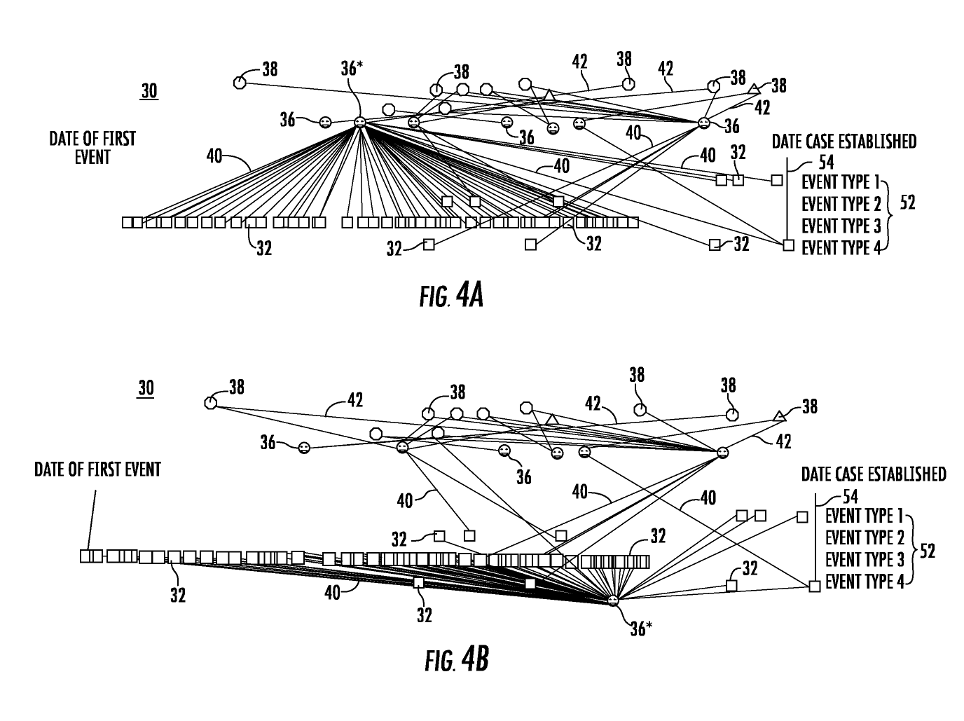

FIGS. 4A and 4B illustrate the moveable nature of icons within the GUI, in accordance with embodiments of the present invention. In specific embodiments of the invention icons may be moved within the GUI by the user (e.g., selected and dragged to desired location) to impart clarity into the visualization of the links that exist and to isolate noise in the suspicious activity (i.e., identify an event or party as truly suspicious or identify an event or party as a normal event/activity or party). In specific embodiments of the GUI, the party icons 36 and the relationship icons 38 are moveable, while the event icons 32 are stationary. In other embodiments of the GUI all of the icons 32, 34, and 38 may be configured to be moveable.

FIG. 4A depicts a GUI 30 as presented to a user for investigation, prior to moving any of the icons. FIG. 4B depicts a GUI 30 after the user has moved party icon 36* from its original location to a location below the event icons 32. In addition, movement of the party icon 36* also moves the corresponding first links 40 and second links 42 associated with the party icon 36*. Movement of party icon 36* imparts more clarity to the GUI 30 and may provide for indication of another event or a party as a truly suspicious event or party or a normal event or party. It certain embodiments of the invention, the event icons determined to be associated with events that are determined to be “normal” behavior/activity can be deleted from the GUI or be otherwise changed in form (i.e., color, shape or the like) to indicate that the event is “normal” (i.e., non-suspicious) activity.

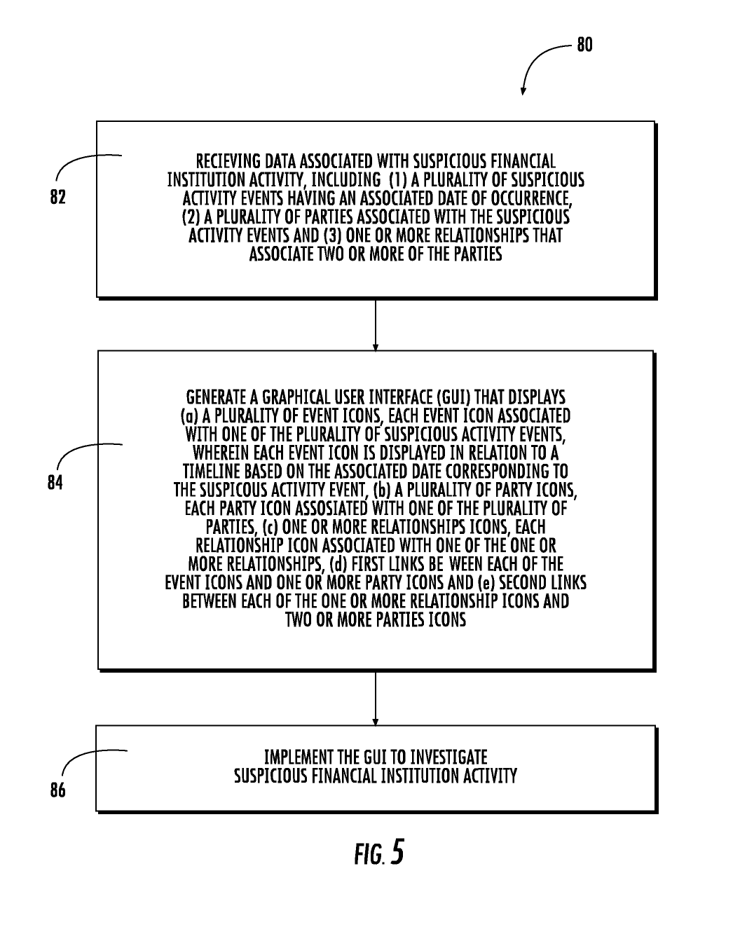

FIG. 5 is a flow diagram of a method 80 for generating a GUI for investigation of suspicious financial institution activity, in accordance with further embodiments of the invention. At Event 82, data associated with suspicious financial institution activity is received. In specific embodiments such data is received and the GUI is generated in automatic response to the suspicious activity being elevated to the case-level (i.e., warranting investigation to determine if a regulatory agency needs to notified/Suspicious Activity Report (SAR) filed).

The data that is received may include, but is not limited to, data associated with (1) a plurality of related suspicious activity events, including a corresponding date of occurrence, (2) a plurality of parties (one or more individuals, e.g., a business/company or the like) associated with the suspicious activity events and (3) one or more relationships that associate two or more parties. The relationships may include, but are not limited to, common household/same address, holders of joint accounts, parties to one or more transactions (e.g., buyer and seller), common employer, parties employed by affiliated companies, common owner of businesses associated with parties, common business location/address and the like.

At Event 84, a GUI is generated for assisting an investigator in the investigation of suspicious activity within the financial institution. The GUI includes a plurality of event icons, each event icon associated with one of the plurality of suspicious activity events. Further, each event icon is displayed in relation to a timeline based on the associated date corresponding to the suspicious activity event. The GUI additionally includes a plurality of party icons, each party icon associated with one of the plurality of parties and one or more relationship icons, each relationship icon associated with one of the one or more relationships. Further the GUI includes first links between each of the event icons and one or more party icons. The first links are configured to provide a correlation between a suspicious activity event and the one or more parties associated with the suspicious activity event. Moreover, the GUI includes second links between each of the one or more relationship icons and two or more of the party icons. The second links are configured to provide a correlation between two or more parties and a relationship that associates the two or more parties.

At Event 86, the GUI is implemented by an investigator to investigate the suspicious activity within the financial institution. In specific embodiments, in which icons are configured to be moveable icons, implementation of the GUI may include movement of icons, specifically the party icons and/or the relationship icons, to impart clarity and to isolate “noise” in the GUI (i.e., identify suspicious events as truly suspicious or identify suspicious event as “normal” business activity). Movement of an icon also imparts movement of the corresponding links associated with the icon being moved.

Thus, as described in detail above, the present invention provides for apparatus, systems, computer program products and methods for generating a GUI for investigation of suspicious activity within a financial institution. Specifically, the GUI of the present invention, through the implementation of visual links, provides an individual or entity tasked with investigating suspicious financial institution activity immediate insight into (1) the relationship between the parties involved and the numerous suspicious activity events and (2) the relationships between the parties. In addition, the GUI of the present provides immediate insight into (3) the relationship between suspicious activity events as it pertains to time of occurrence and types of events. Moreover, the fluid “moveable” nature of the elements illustrated in the GUI provides the investigator visual flexibility that aids in (a) verifying that a suspicious event is, in fact, suspicious; (b) identifying events that are normal business activity; and (c) identifying potential suspects.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for generating a graphical user interface (GUI) configured for investigating suspicious activity in a financial institution, the apparatus comprising:
a computing platform having a memory and at least one processor in communication with the memory; and
a GUI-generating module stored in the memory, executable by the processor and configured to:
receive data associated with suspicious financial institution activity, including (1) a plurality of suspicious activity events having an associated date of occurrence, (2) a plurality of parties associated with the suspicious activity events and (3) one or more relationships that associate two or more of the parties,
generate a graphical user interface (GUI) that displays:
a plurality of event icons, each event icon associated with one of the plurality of suspicious activity events, wherein each event icon is displayed in relation to a timeline based on the associated date corresponding to the suspicious activity event,
a plurality of party icons, each party icon associated with one of the plurality of parties,
one or more relationship icons, each relationship icon associated with one of the one or more relationships,
first links between each of the event icons and one or more party icons, wherein the first links are configured to provide a correlation between a suspicious activity event and the one or more parties associated with the suspicious activity event, and
second links between each of the one or more relationship icons and two or more of the party icons, wherein the second links are configured to provide a correlation between two or more parties and a relationship that associates the two or more parties.

2. The apparatus of claim 1, wherein the GUI-generating module is further configured to generate the GUI that displays the plurality of party icons, wherein the party icons are moveable icons within the display, wherein movement of a party icon serves to (1) verify suspicious nature of correlated suspicious activity events or (2) identify correlated suspicious activity events as normal business behavior.

3. The apparatus of claim 2, wherein the GUI-generating module is further configured to generate the GUI that displays the party icons, wherein movement of a party icon provides for movement of the first and second links associated with the party icon.

4. The apparatus of claim 1, wherein the GUI-generating module is further configured to generate the GUI that displays the plurality of relationship icons, wherein the relationship icons are moveable icons within the display, wherein movement of a relationship icon provides for movement of the second links associated with the relationship icon.

5. The apparatus of claim 1, wherein the GUI-generating module is further configured to receive the data associated with the suspicious financial institution activity in response to the suspicious financial institution activity being associated with a risk score that exceeds a threshold for designating the suspicious financial institution activity as a case for investigation.

6. The apparatus of claim 5, wherein the GUI-generating module is further configured to generate the GUI that displays a case indicator in relation to the timeline, wherein the case indicator provides an indication of when the suspicious financial institution activity was designated as the case.

7. The apparatus of claim 1, wherein the GUI-generating module is further configured to generate the GUI that displays the timeline that is scaled relative to (1) a first date corresponding to an occurrence of a first-in-time suspicious activity event and (2) a second date corresponding to an occurrence of a case being established.

8. The apparatus of claim 1, wherein the GUI-generating module is further configured to generate the GUI that displays the plurality of event icons, wherein the event icons are grouped in the display according to suspicious activity event type.

9. The apparatus of claim 1, wherein the GUI-generating module is further configured to generate the GUI that displays the one or more relationship icons, wherein the relationship icons visually indicate a type of relationship associated with the relationship icon.

10. A method for generating and implementing a graphical user interface (GUI) configured for investigating suspicious activity in a financial institution, the method comprising:
receiving, at a computing device, data associated with suspicious financial institution activity, including (1) a plurality of suspicious activity events having an associated date of occurrence, (2) a plurality of parties associated with the suspicious activity events and (3) one or more relationships that associate two or more of the parties;
generating, by a computing device processor, a graphical user interface (GUI) that displays:
a plurality of event icons, each event icon associated with one of the plurality of suspicious activity events, wherein each event icon is displayed in relation to a timeline based on the associated date corresponding to the suspicious activity event,
a plurality of party icons, each party icon associated with one of the plurality of parties,
one or more relationship icons, each relationship icon associated with one of the one or more relationships,
first links between each of the event icons and one or more party icons, wherein the first links are configured to provide a correlation between a suspicious activity event and the one or more parties associated with the suspicious activity event, and
second links between each of the one or more relationship icons and two or more of the party icons, wherein the second links are configured to provide a correlation between two or more parties and a relationship that associates the two or more parties; and
implementing the GUI to investigate the suspicious financial institution activity.

11. The method of claim 10, wherein generating the GUI further comprises generating the GUI that displays the plurality of party icons, wherein the party icons are moveable icons within the display.

12. The method of claim 11 further comprising receiving, at a computing device, a user input that is configured to move a party icon within the display to perform one of (1) verify suspicious nature of correlated suspicious activity events or (2) identify correlated suspicious activity events as normal business behavior.

13. The method of claim 10, wherein generating the GUI further comprises generating the GUI that displays the plurality of relationship icons, wherein the relationship icons are moveable icons within the display.

14. The method of claim 13, further comprising receiving, at a computing device, a user input that is configured to move a relationship icon to add clarity to the GUI.

15. The method of claim 10, further comprising:
determining, by a computing device, a risk score associated with the suspicious financial institution activity; and
identifying, by a computing device, the suspicious financial institution activity as a case for investigation based on the risk score exceeding a threshold for designating the suspicious financial institution activity for case investigation,
wherein receiving the data further comprises receiving the data associated with the suspicious financial institution activity in automatic response to identifying the suspicious financial institution activity as the case for investigation.

16. The method of claim 15, wherein generating the GUI further comprises generating the GUI that displays a case indicator in relation to the timeline, wherein the case indicator provides an indication of when the suspicious financial institution activity was designated as the case.

17. The method of claim 10, wherein the generating the GUI further comprises generating the GUI that displays the timeline, wherein the timeline is scaled relative to (1) a first date corresponding to an occurrence of a first-in-time suspicious activity event and (2) a second date corresponding to an occurrence of a case being established.

18. The method of claim 10, wherein generating the GUI further comprises generating the GUI that displays the plurality of event icons, wherein the event icons are grouped in the display according to suspicious activity event type.

19. The method of claim 10, wherein generating the GUI further comprises generating the GUI that displays the one or more relationship icons, wherein the relationship icons visually indicate a type of relationship associated with the relationship icon.

20. A computer program product comprising:
a non-transitory computer-readable medium comprising:
a first set of codes for causing a computer to receive data associated with suspicious financial institution activity, including (1) a plurality of suspicious activity events having an associated date of occurrence, (2) a plurality of parties associated with the suspicious activity events and (3) one or more relationships that associate two or more of the parties; and
a second set of codes for generating a graphical user interface (GUI) that displays (1) a plurality of event icons, each event icon associated with one of the plurality of suspicious activity events, wherein each event icon is displayed in relation to a timeline based on the associated date corresponding to the suspicious activity event, (2) a plurality of party icons, each party icon associated with one of the plurality of parties, (3) one or more relationship icons, each relationship icon associated with one of the one or more relationships, (4) first links between each of the event icons and one or more party icons, wherein the first links are configured to provide a correlation between a suspicious activity event and the one or more parties associated with the suspicious activity event, and (5) second links between each of the one or more relationship icons and two or more of the party icons, wherein the second links are configured to provide a correlation between two or more parties and a relationship that associates the two or more parties.

21. The computer program product of claim 20, wherein the second set of codes is further configured to cause the computer to generate the GUI that displays the plurality of party icons, wherein the party icons are moveable icons within the display and further comprising a third set of codes for causing a computer to receive a user input that is configured to move a party icon within the display to perform one of (1) verify suspicious nature of correlated suspicious activity events or (2) identify correlated suspicious activity events as normal business behavior.

22. The computer program product of claim 20, further comprising:
a third set of codes for causing a computer to determine a risk score associated with the suspicious financial institution activity; and
a fourth set of codes for identifying the suspicious financial institution activity as a case for investigation based on the risk score exceeding a threshold for designating the suspicious financial institution activity for case investigation, and
wherein the first set of codes is further configured to cause the computer to receive the data associated with the suspicious activity in automatic response to identifying the suspicious activity as the case for investigation.

23. The computer program product of claim 22, wherein the second set of codes is further configured to cause the computer to generate the GUI that displays a case indicator in relation to the timeline, wherein the case indicator provides an indication of when the suspicious activity was designated as the case.

24. The computer program product of claim 20, wherein the second set of codes is further configured to cause the computer to generate the GUI that displays the timeline, wherein the timeline is scaled relative to (1) a first date corresponding to an occurrence of a first-in-time suspicious activity event and (2) a second date corresponding to an occurrence of a case being established.
